(19) United States
(12) Patent Application Publication
(10) Pub. No.: US 2013/0082097 A1
(43) Pub. Date: Apr. 4, 2013

(54) EXPENDITURE COUNTING SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/285,037

(22) Filed: Oct. 31, 2011

(30) Foreign Application Priority Data
Sep. 30, 2011 (TW) 100135421

(51) Int. Cl. G06F 17/00

(52) U.S. Cl. 235/375

(57) ABSTRACT

An expenditure counting method includes: capturing an image of a barcode on the package of goods with a camera, decoding the image of the barcode to obtain a price of the goods, storing the price of the goods in a first storing module. Adding up prices stored in the first storing module to obtain a sum price, comparing the sum price with a maximum expenditure, and informing the user that the sum price exceeds the maximum expenditure if the sum price is greater than maximum expenditure.

### BACKGROUND

1. Technical Field

The present disclosure relates to a system and method for counting expenditures.

2. Description of Related Art

Many expenditure counting systems need to manually input expenditure. This is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an expenditure counting system.

FIGS. 2-5 are schematic diagrams of the expenditure counting system of FIG. 1 in a working state.

FIG. 6 is a flowchart of an exemplary embodiment of an expenditure counting method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

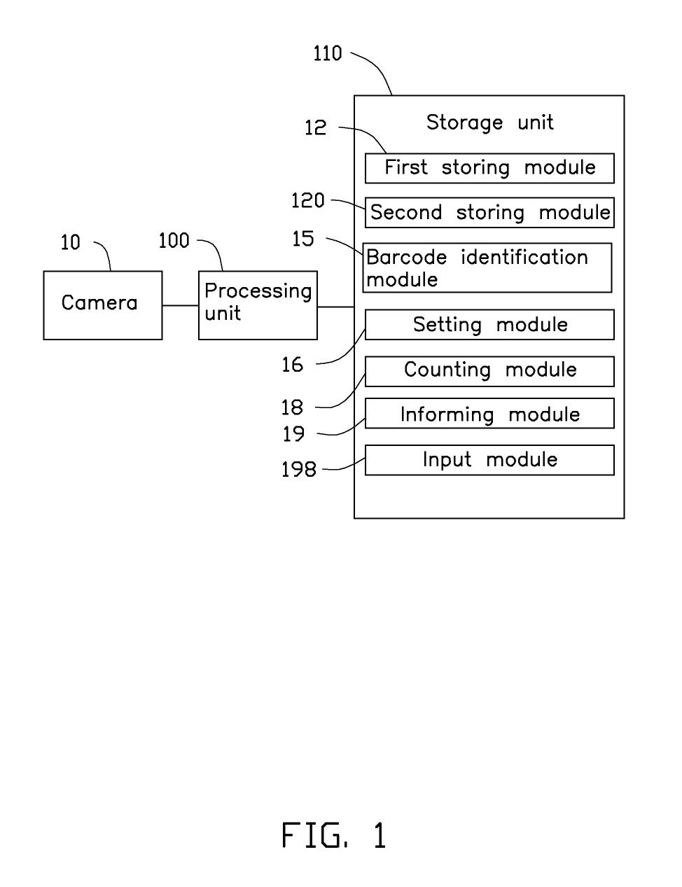

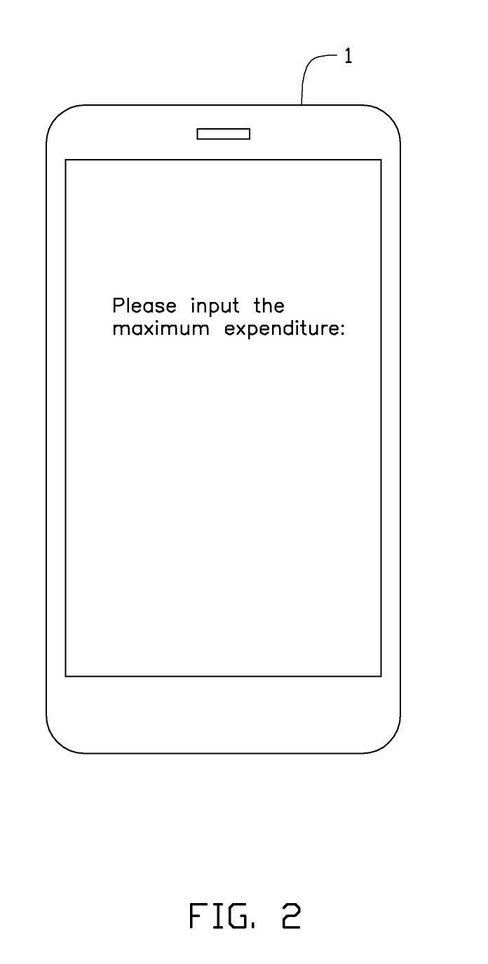

Referring to FIG. 1, an exemplary embodiment of an expenditure counting system includes a camera 10, a processing unit 100, and a storage unit 110. The storage unit 110 includes a first storing module 12, a second storing module 120, a barcode identification module 15, a setting module 16, a counting module 18, an informing module 19, and an input module 198, which may include computer code to be executed by the processing unit 100. In this embodiment, the expenditure counting system is embedded in a handheld device, such as a mobile phone 1 (shown in FIG. 2). A camera of the mobile phone 1 can be regarded as the camera 10 of the expenditure counting system.

The camera 10 captures images of barcodes on goods packages. The barcode identification module 15 decodes the images of the barcodes to obtain the price of each goods. The barcode identification module 15 is well-known and used in many mobile phones. The price of goods are stored in the first storing module 12. In this embodiment, the first storing module 12 stores the prices obtained by the camera 10 and the barcode identification module 15 on a daily basis.

The counting module 18 adds up the prices for one day stored in the first storing module 12 to obtain a first sum price.

A first maximum expenditure is set through the setting module 16 by the user. When the first maximum expenditure of the user is set, the first maximum expenditure is stored in the second storing module 120.

The counting module 18 further compares the first sum price with the first maximum expenditure. If the first sum price is greater than the first maximum expenditure, the informing module 19 informs the user that the first sum price exceeds the first maximum expenditure for the day. If the first sum price is less than or equals to the first maximum expenditure, the informing module 19 displays a first remaining expenditure for the day. The first remaining expenditure is a difference between the first maximum expenditure and the first sum price, namely, when the first sum price equals to the first maximum expenditure, the remaining expenditure for the day is zero.

In other embodiments, the first storing module 12 can store goods prices obtained by the camera 10 and the barcode identification module 15 for each meal, such as breakfast, lunch, or dinner. A second maximum expenditure for each meal is also set through the setting module 16 by the user. The counting module 18 further adds the prices of goods for a meal to obtain a second sum price. In this embodiment, the counting module 18 compares the second sum prices with the second maximum expenditure. If the second sum price is greater than the second maximum expenditure, the informing module 19 informs the user that the second sum price exceeds the second maximum expenditure for this meal. If the second sum price is less than or equal to the second maximum expenditure, the informing module 19 displays the remaining expenditure. The remaining expenditure is a difference between the second maximum expenditure and the second sum price.

In addition, if one of the goods has no barcode, such as breakfast cooked by the user, the user can input the price of the breakfast manually through the input module 198. The price of the breakfast is also stored in the first storing module 12.

Referring to FIG. 2, when the expenditure counting system is activated, the counting system informs the user to input the maximum expenditure through the setting module 16. The maximum expenditure is stored in the second storing module 120.

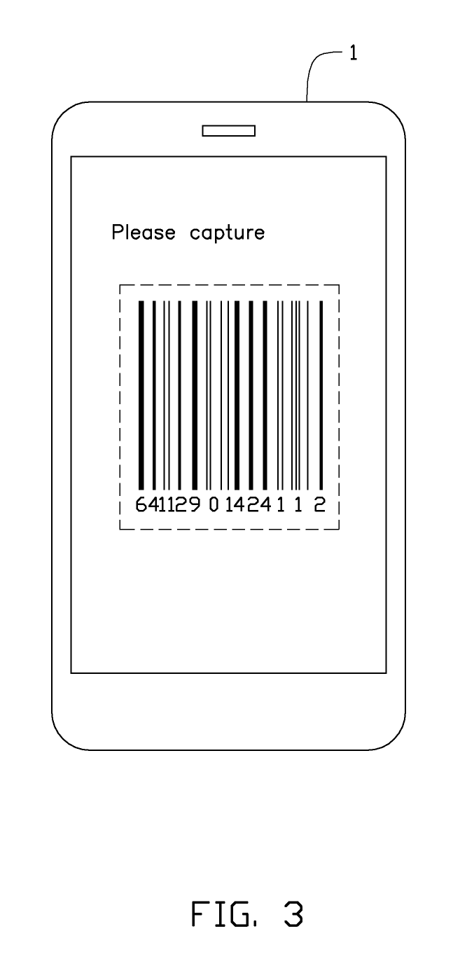

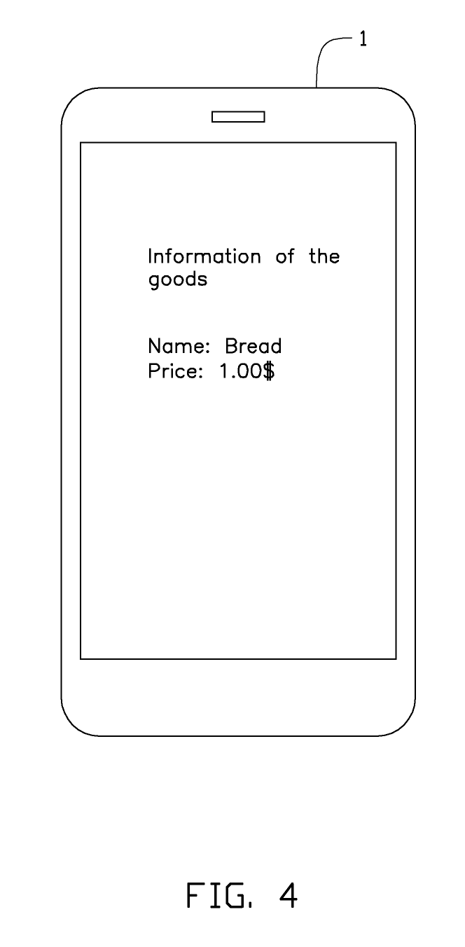

Before the user buys one of the goods, the user captures an image of the barcode on the goods (shown in FIG. 3) using the camera 10. The barcode identification module 15 decodes the image of the barcode to obtain the information of the goods, such as a name and the price of the goods (shown in FIG. 4).

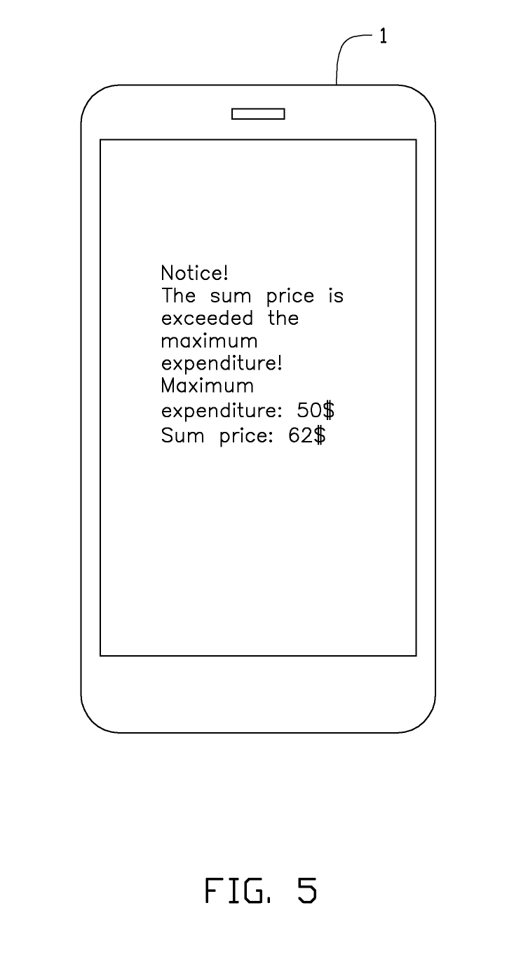

The counting module 18 adds up the prices stored in the first storing module 12 for the day or this meal to obtain the sum price, and compares the sum price with the maximum expenditure. As shown in FIG. 5, if the sum price is greater than the maximum expenditure, the informing module 19 informs the user that the sum price exceeds the maximum expenditure for the day or for this meal, and displays the sum price and the maximum expenditure.

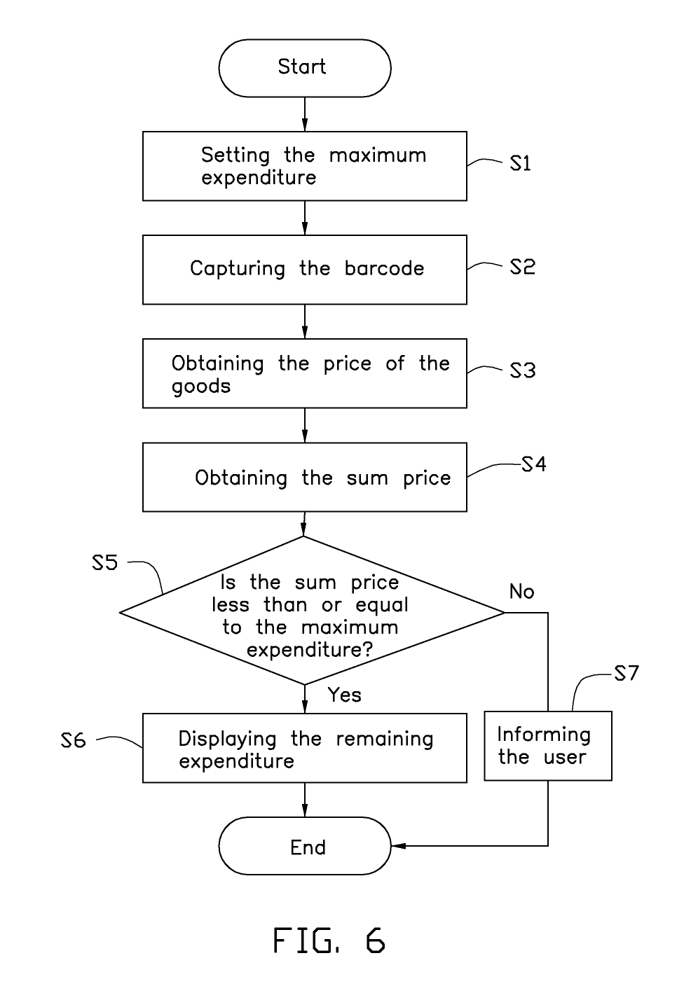

Referring to FIG. 6, an exemplary embodiment of an expenditure counting method includes the following steps.

In step S1, the maximum expenditure for one day or one meal is set through the setting module 16.

In step S2, the camera 10 captures an image of a barcode on one goods package.

In step S3, the barcode identification module 15 decodes the image of the barcode to obtain the price of the goods. The price is stored in the first storing module 12.

In step S4, the counting module 18 adds up the prices stored in the first storing module 120 to obtain the sum price.

In step S5, the counting module 18 compares the sum price with the maximum expenditure. If the sum price is greater than the maximum expenditure, it flows to step S6. If the sum price is less than or equal to the maximum expenditure, it flows to step S7.

In step S6, the informing module 19 informs the user that the sum price exceeds the maximum expenditure for the day or for this meal.

In step S7, the informing module 19 displays the remaining expenditure for the day or for this meal.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An expenditure counting system comprising:
a camera to capture an image of a barcode on one goods;
a processing unit connected to the camera; and
a storage unit connected to the processing unit and storing a plurality of programs to be executed by the processing unit, wherein the storage unit comprises:
a barcode identification module to decode the image of the barcode for obtaining a price of the goods;
a first storing module to store prices of a plurality of goods obtained by the barcode identification module;
a counting module to add up the prices stored in the first storing module to obtain a sum price, and compares the sum price with a maximum expenditure; and
an informing module, wherein if the sum price is greater than the maximum expenditure, the informing module informs the user that the sum price exceeds the maximum expenditure.

2. The system of claim 1, wherein the storage unit further comprises:
a setting module to set the maximum expenditure.

3. The system of claim 1, wherein the storage unit further comprises:
an input module to input a price of one goods.

4. The system of claim 1, wherein if the sum price is less than or equal to the maximum expenditure, the informing module displays a remaining expenditure, the remaining expenditure is a difference between the maximum expenditure and the sum price.

5. An expenditure counting method comprising:
capturing an image of a barcode on one goods package through a camera;
decoding the image of the barcode to obtain a price of the goods;
storing the price of the goods in a first storing module;
adding up prices stored in the first storing module to obtain a sum price;
comparing the sum price with a maximum expenditure; and
informing a user that the sum price exceeds the maximum expenditure if the sum price is greater than the maximum expenditure.

6. The method of claim 5, wherein before the step of “capturing an image of a barcode on one goods package through a camera” the method comprising:
setting the maximum expenditure.

7. The method of claim 5, wherein after the step “comparing the sum price with the maximum expenditure” the method comprising:
displaying a remaining expenditure, wherein the remaining expenditure is a difference between the maximum expenditure and the sum price.
